(19) United States
(12) Patent Application Publication
(10) Pub. No.: US 2009/0244301 A1
(43) Pub. Date: Oct. 1, 2009

(54) CONTROLLING MULTIPLE-IMAGE CAPTURE

(76) Inventors: John N. Border, Walworth, NY (US); Bruce H. Pillman, Rochester, NY (US); John F. Hamilton, JR., Rochester, NY (US); Amy D. Enge, Spencerport, NY (US)

Correspondence Address: J. Lanny Tucker;Patent Legal Staff, Eastman Kodak Company, 343 State Street, Rochester, NY, 14650-2201, US

(21) Appl. No.: 12/060,520

(22) Filed: Apr. 1, 2008

(51) Int. Cl. H04N 5/228; H04N 5/217

(52) U.S. Cl. 348/208.99; 348/241; 348/E05.078; 348/E05.031

(57) ABSTRACT

According to some embodiments of the present invention, pre-capture information is acquired, and based at least upon an analysis of the pre capture information, it may be determined that a multiple-image capture is to be performed, where the multiple-image capture is configured to acquire multiple images for synthesis into a single image. Subsequently, execution of the multiple-image capture is performed.

### FIELD OF THE INVENTION

The invention relates to, among other things, controlling image capture to include the capture of multiple images based at least upon an analysis of pre-capture information.

### BACKGROUND

In capturing a scene with a camera, many parameters affect the quality and usefulness of the captured image. In addition to controlling overall exposure, exposure time affects motion blur, f/number affects depth of field, and so forth. In many cameras, all or some of these parameters can be controlled and are conveniently referred to as camera settings.

Methods for controlling exposure and focus are well known in both film-based and electronic cameras. However, the level of intelligence in these systems is limited by resource and time constraints in the camera. In many cases, knowing the type of scene being captured can lead easily to improved selection of capture parameters. For example, knowing a scene is a portrait allows the camera to select a wider aperture, to minimize depth of field. Knowing a scene is a sports/action scene allows the camera to automatically limit exposure time to control motion blur and adjust gain (exposure index) and aperture accordingly. Because this knowledge is useful in guiding simple exposure control systems, many film, video, and digital still cameras include a number of scene modes that can be selected by the user. These scene modes are essentially collections of parameter settings, which direct the camera to optimize parameters, given the user's selection of scene type.

The use of scene modes is limited in several ways. One limitation is that the user must select a scene mode for it to be effective, which is often inconvenient, even if the user understands the utility and usage of the scene modes.

A second limitation is that scene modes tend to oversimplify the possible kinds of scenes being captured. For example, a common scene mode is “portrait”, optimized for capturing images of people. Another common scene mode is “snow”, optimized to capture a subject against a background of snow, with different parameters. If a user wishes to capture a portrait against a snowy background, they must choose either portrait or snow, but they cannot combine aspects of each. Many other combinations exist, and creating scene modes for the varying combinations is cumbersome at best.

In another example, a backlit scene can be very much like a scene with a snowy background, in that subject matter is surrounded by background with a higher brightness. Few users are likely to understand the concept of a backlit scene and realize it has crucial similarity to a “snow” scene. A camera developer wishing to help users with backlit scenes will probably have to add a scene mode for backlit scenes, even though it may be identical to the snow scene mode.

Both of these scenarios illustrate the problems of describing photographic scenes in way accessible to a casual user. The number of scene modes required expands greatly and becomes difficult to navigate. The proliferation of scene modes ends up exacerbating the problem that many users find scene modes excessively complex.

Attempts to automate the selection of a scene mode have been made. Such attempts use information from evaluation images and other data to determine a scene mode. The scene mode then is used to select a set of capture parameters from several sets of capture parameters that are optimized for each scene mode. Although these conventional techniques have some benefits, there is still a need in the art for improved solutions for determining scene modes or image capture parameters particularly when multiple images are captured and combined to form an improved single image.

### SUMMARY

The above-described problems are addressed and a technical solution is achieved in the art by systems and methods for controlling an image capture, according to various embodiments of the present invention. In some embodiments, pre-capture information is acquired. The pre-capture information may indicate at least scene conditions, such as a light level of a scene or motion of at least a portion of a scene. A multiple-image capture may then be determined by a determining step to be appropriate based at least upon an analysis of the pre-capture information, the multiple-image capture being configured to acquire multiple images for synthesis into a single image.

For example, the determining step may include determining that a scene cannot be captured effectively by a single image-capture based at least upon an analysis of scene conditions and, consequently, that the multiple-image capture is appropriate. In cases where the pre-capture information indicates a light level of a scene, the determining step may determine that the light-level is insufficient for the scene to be captured effectively by a single image-capture. In cases where the pre-capture information indicates motion of at least a portion of a scene, the determining step may include determining that the motion would cause blur to be too great in a single image-capture. Similarly, in cases where the pre-capture information indicates different motion in at least two portions of a scene, the determining step may include determining that at least one of the different motions would cause blur to be too great in a single image-capture.

In some embodiments of the present invention, the multiple-image-capture includes capture of heterogeneous images. Such heterogeneous images may include, for example, images that differ by resolution; integration time; exposure time; frame rate; pixel type, such as pan pixel types or color pixel types; focus; noise cleaning methods; gain settings; tone rendering; or flash mode. In this regard, in some embodiments where the pre-capture information indicates local motion present only in a portion of a scene, the determining step includes determining, in response to the local motion, that the multiple-image-capture is to be configured to capture multiple heterogeneous images. Further in this regard, at least one of the multiple heterogeneous images may include an image that includes only the portion or substantially the portion of the scene exhibiting the local motion. In some embodiments, an image-capture-frequency for the multiple-image capture is determined based at least upon an analysis of the pre-capture information.

Further, in some embodiments, when a multiple-image capture is deemed appropriate, execution of such multiple-image capture is instructed, for example, by a data processing system.

In addition to the embodiments described above, further embodiments will become apparent by reference to the drawings and by study of the following detailed description.

### BRIEF DESCRIPTION OF THE DRAWINGS

The present invention will be more readily understood from the detailed description of exemplary embodiments presented below considered in conjunction with the attached drawings, of which:

FIG. 1 illustrates a system for controlling an image capture, according to an embodiment of the invention;

FIG. 2 illustrates a method according to a first embodiment of the invention where pre-capture information is used to determine a level of motion present in a scene, which is used to determine whether a single-image capture or a multiple-image capture is deemed appropriate;

FIG. 3 illustrates a method according to another embodiment of the invention where motion is detected and a multiple-image capture is deemed appropriate and selected;

FIG. 4 illustrates a method according to a further embodiment of the invention in which both global motion and local motion are evaluated to determine whether a multiple-image capture is appropriate;

FIG. 5 illustrates a method that expands upon step 495 in FIG. 4, according to an embodiment of the present invention, wherein a local motion capture set is defined;

FIG. 6 illustrates a method according to yet another embodiment of the invention in which flash is used to illuminate a scene during at least one of the image captures in a multiple-image capture; and

FIG. 7 illustrates a method according to an embodiment of the present invention for synthesizing multiple images from a multiple-image capture into a single image, for example, by leaving out high-motion images from the synthesizing process.

It is to be understood that the attached drawings are for purposes of illustrating the concepts of the invention and may not be to scale.

### DETAILED DESCRIPTION

Embodiments of the present invention pertain to data processing systems, which may be located within a digital camera, for example, that analyze pre-capture information to determine whether multiple images should be acquired and synthesized into an individual image. Accordingly, embodiments of the present invention determine based at least upon pre-capture information when the acquisition of multiple images configured to produce a single synthesized image will have improved qualities over a single-image capture. For example, embodiments of the present invention determine, at least from pre-capture information that indicates low-light or high-motion scene conditions, that a multiple-image capture is appropriate, as opposed to a single-image capture.

It should be noted that, unless otherwise explicitly noted or required by context, the word “or” is used in this disclosure in a non-exclusive sense.

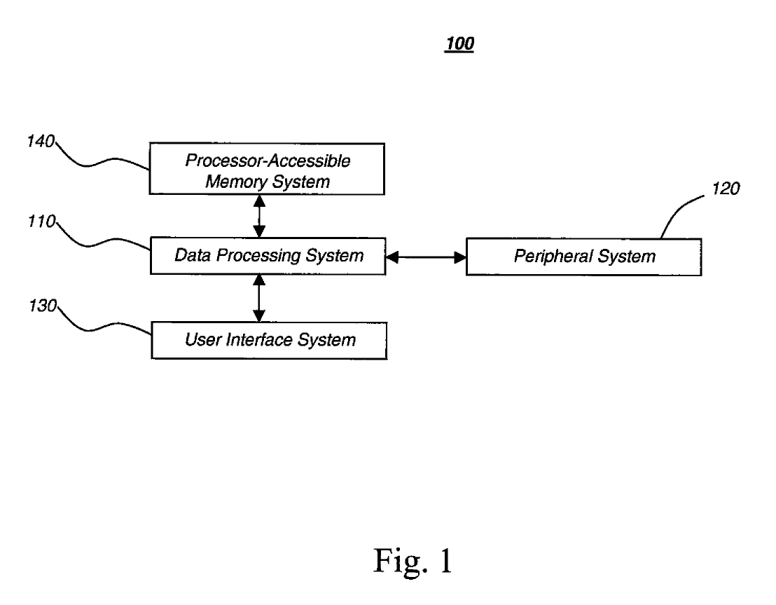

FIG. 1 illustrates a system 100 for controlling an image capture, according to an embodiment of the present invention. The system 100 includes a data processing system 110, a peripheral system 120, a user interface system 130, and a processor-accessible memory system 140. The processor-accessible memory system 140, the peripheral system 120, and the user interface system 130 are communicatively connected to the data processing system 110.

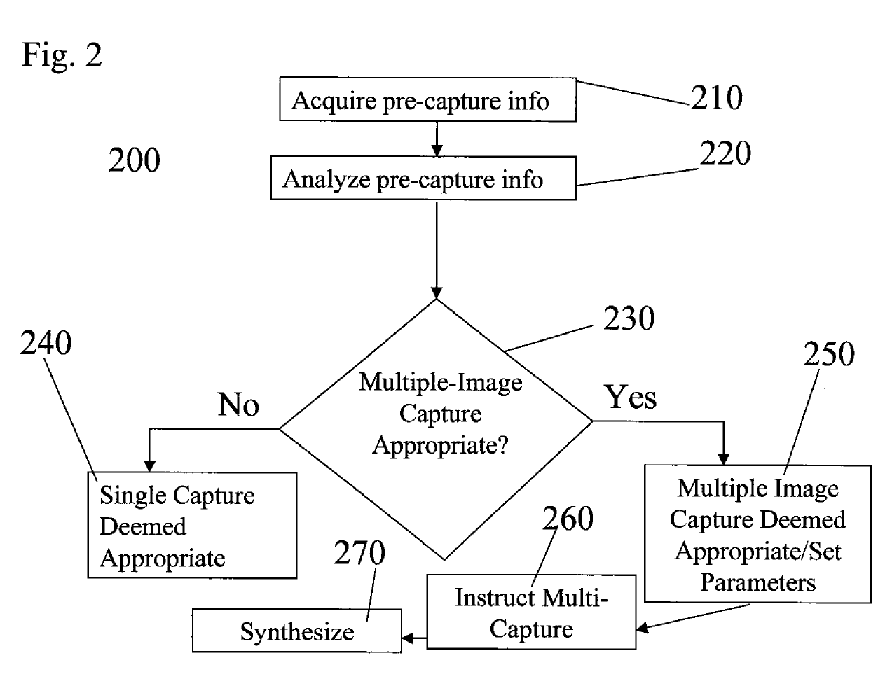

The data processing system 110 includes one or more data processing devices that implement the processes of the various embodiments of the present invention, including the example processes of FIGS. 2-7 described herein. The phrases “data processing device” or “data processor” are intended to include any data processing device, such as a central processing unit (“CPU”), a desktop computer, a laptop computer, a mainframe computer, a personal digital assistant, a Blackberry, a digital camera, cellular phone, or any other device for processing data, managing data, or handling data, whether implemented with electrical, magnetic, optical, biological components, or otherwise.

The processor-accessible memory system 140 includes one or more processor-accessible memories configured to store information, including the information needed to execute the processes of the various embodiments of the present invention, including the example processes of FIGS. 2-7 described herein. The processor-accessible memory system 140 may be a distributed processor-accessible memory system including multiple processor-accessible memories communicatively connected to the data processing system 110 via a plurality of computers and/or devices. On the other hand, the processor-accessible memory system 140 need not be a distributed processor-accessible memory system and, consequently, may include one or more processor-accessible memories located within a single data processor or device.

The phrase “processor-accessible memory” is intended to include any processor-accessible data storage device, whether volatile or nonvolatile, electronic, magnetic, optical, or otherwise, including but not limited to, registers, floppy disks, hard disks, Compact Discs, DVDs, flash memories, ROMs, and RAMs.

The phrase “communicatively connected” is intended to include any type of connection, whether wired or wireless, between devices, data processors, or programs in which data may be communicated. Further, the phrase “communicatively connected” is intended to include a connection between devices or programs within a single data processor, a connection between devices or programs located in different data processors, and a connection between devices not located in data processors at all. In this regard, although the processor-accessible memory system 140 is shown separately from the data processing system 110, one skilled in the art will appreciate that the processor-accessible memory system 140 may be stored completely or partially within the data processing system 110. Further in this regard, although the peripheral system 120 and the user interface system 130 are shown separately from the data processing system 110, one skilled in the art will appreciate that one or both of such systems may be stored completely or partially within the data processing system 110.

The peripheral system 120 may include one or more devices configured to provide pre-capture information and captured images to the data processing system 110. For example, the peripheral system 120 may include light level sensors, motion sensors including gyros, electromagnetic field sensors or infrared sensors known in the art that provide (a) pre-capture information, such as scene-light-level information, electromagnetic field information or scene-motion-information or (b) captured images. The data processing system 110, upon receipt of pre-capture information or captured images from the peripheral system 120, may store such information in the processor-accessible memory system 140.

The user interface system 130 may include any device or combination of devices from which data is input by a user to the data processing system 110. In this regard, although the peripheral system 120 is shown separately from the user interface system 130, the peripheral system 120 maybe included as part of the user interface system 130.

The user interface system 130 also may include a display device, a processor-accessible memory, or any device or combination of devices to which data is output by the data processing system 110. In this regard, if the user interface system 130 includes a processor-accessible memory, such memory may be part of the processor-accessible memory system 140 even though the user interface system 130 and the processor-accessible memory system 140 are shown separately in FIG. 1.

FIG. 2 illustrates a method 200 for a first embodiment of the invention where pre-capture information is used to determine a level of motion present in a scene, which is used to determine whether a single-image capture or a multiple-image capture is deemed appropriate. In step 210, pre-capture information is acquired by the data processing system 110. Such pre-capture information may include: two or more pre-capture images, gyro information (camera motion), GPS location information, light level information, audio information, focus information and motion information.

The pre-capture information is then analyzed in step 220 to determine scene conditions, such as a light-level of a scene or motion in at least a portion of the scene. In this regard, the pre-capture information may include any information useful for determining whether relative motion between the camera and the scene is present or motion can reasonably be anticipated to be present during the image capture so that an image of a scene would be of better quality if captured via a multiple-image capture set as opposed to a single-image capture. Examples of pre-image capture information include: total exposure time (which is a function of light level present in a scene); motion (e.g., speed and direction) in at least a portion of the scene; motion differences between different portions of the scene; focus information; direction and location of the device (such as the peripheral system 120); gyro information; range data; rotation data; object identification; subject location; audio information; color information; white balance; dynamic range; face detection and pixel noise position. In step 230, based at least upon the analysis performed in step 220, a determination is made as to whether an image of the scene is best captured by a multiple-image capture as opposed to a single-image capture. In other words, a determination is made in step 230 as to whether a multiple-image capture is appropriate, based at least upon the analysis of the pre-capture information performed in step 220. For example, motion present in a scene, as determined by the analysis in step 220, may be compared to the total exposure time (a function of light level) needed to properly capture an image of the scene. If low motion is detected relative to the total exposure time, such that a level of motion blur is acceptable, a single-image capture is deemed appropriate in step 240. If high motion is detected relative to the total exposure time such that the level of motion blur is unacceptable, a multiple-image capture is deemed appropriate in step 250. In other words, if light level of a scene is too low, such that it causes motion in the scene to be unacceptably exacerbated, then a multiple-image capture is deemed appropriate in step 230. A multiple image capture can also be deemed appropriate if extended depth of field or extended dynamic range are desired where multiple images with different focus distances or different exposure times can be used to produce an improved synthesized image. A multiple image capture can further be deemed appropriate when the camera is in a flash mode where some of the images captured in the multiple image capture set are captured with flash and some are captured without flash and portions of the images are used to produce an improved synthesized image.

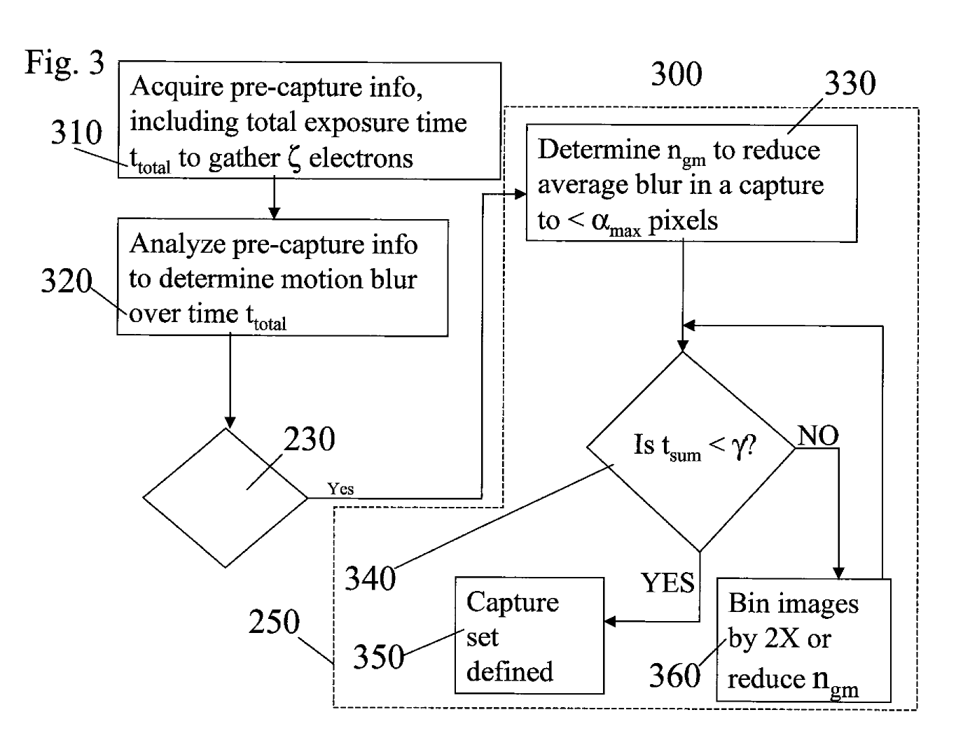

Also in step 250, parameters for the multiple-image capture are set as described, for example, with reference to FIGS. 3-6, below.

If the decision in step 230 is affirmative, then in step 260, the data processing system 110 may instruct execution of the multiple-image capture, either automatically or in response to receipt of user input, such as a depression of a shutter trigger. In this regard, the data processing system 110 may instruct the peripheral system 120 to perform the multiple-image capture. In step 270, the multiple images are synthesized to produce an image with improved image characteristics including reduced blur as compared to what would have been acquired by a single-image capture in step 240. In this regard, the multiple images in a multiple-image capture are used to produce an image with improved image characteristics by assembling at least portions of the multiple images into a single image using methods such as those described in U.S. patent application Ser. No. 11/548,309 (Attorney Docket 92543), titled “Digital Image with Reduced Object Motion Blur”; U.S. Pat. No. 7,092,019, titled “Image Capturing Apparatus and Method Therefore”; or U.S. Pat. No. 5,488,674, titled “Method for Fusing Images and Apparatus Thereof”.

Although not shown in FIG. 2, if the decision in step 230 is negative, then the data processing system 110 may instruct execution of a single-image capture.

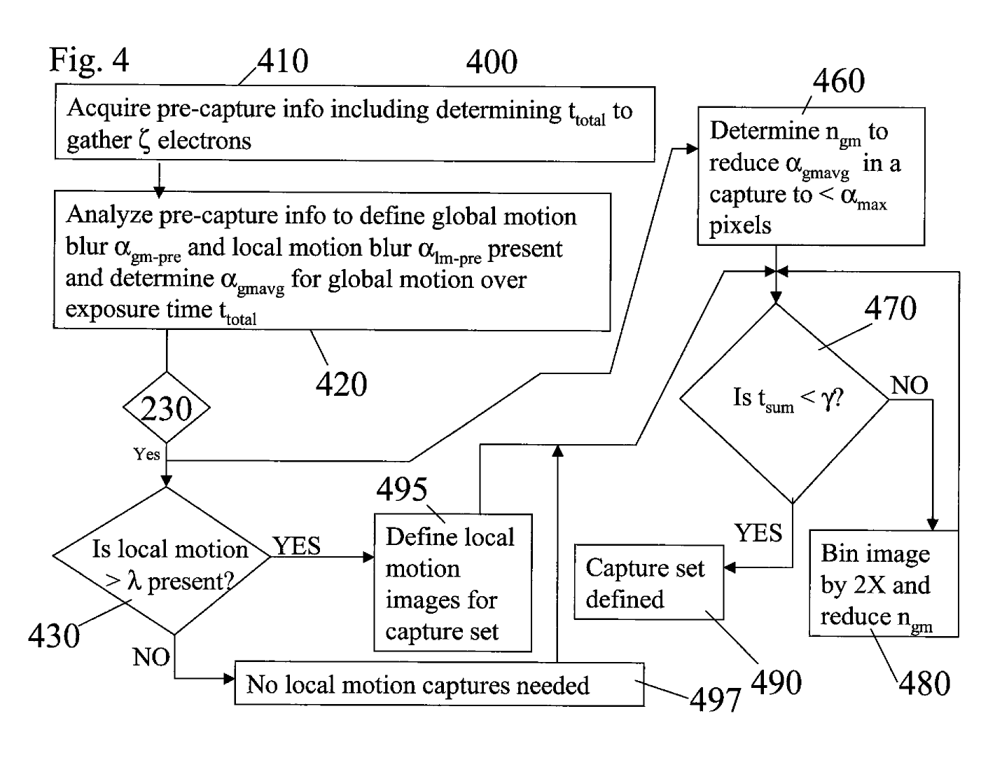

It should be noted that all of the remaining embodiments described herein assume that the decision in step 230 is that a multiple-image capture is appropriate, e.g., that motion detected in the pre-capture information relative to the total exposure time would cause an unacceptable level of motion blur (high motion) in a single image. Consequently, FIGS. 3, 4, and 6 only show the “yes” exit from step 230, and the steps thereafter in these figures illustrate some examples of particular implementations of step 250. In this regard, step 310 in FIG. 3 and step 410 in FIG. 4 illustrate examples of particular implementations of step 210 in FIG. 2. Likewise, step 320 in FIG. 3 and step 420 in FIG. 4 illustrate examples of particular implementations of step 220 in FIG. 2.

FIG. 3 illustrates a method 300 according to another embodiment of the invention where motion is detected and a multiple-image capture is deemed appropriate and selected. This embodiment is suited for, among other things, imaging where limited local motion is present, because the motion present during image capture is treated as global motion wherein the motion can be described as a uniform average value over the entire image. In step 310, which corresponds to step 210 in FIG. 2, acquired pre-capture information includes total exposure time tₜₒₜₐₗ needed to gather ζ electrons. ζ is a desired number of electrons/pixel to produce an acceptably bright image with low noise, and ζ can be determined based on an average, a maximum, or a minimum amongst the pixels depending on the dynamic range limits imposed on the image to be produced. In this regard, the total exposure time tₜₒₜₐₗ acquired in step 310 is a function of light-level in the scene being reviewed. The total exposure time tₜₒₜₐₗ may be determined in step 310 as part of the acquisition of one or more pre-capture images by, for example, the peripheral system 120. For instance, the peripheral system 120 may be configured to acquire a pre-capture image that gathers ζ electrons. The amount of time it takes to acquire such image indicates the total exposure time tₜₒₜₐₗ to gather ζ electrons. In this regard, it can be said that the pre-capture information acquired at step 310 may include pre-capture images.

In step 320, the pre-capture information acquired in step 310 is analyzed to determine additional information including motion blur present in the scene, such as an average motion blur α_{gmavg} (in pixels) from global motion over the total exposure time tₜₒₜₐₗ. Wherein motion blur is typically measured in terms of pixels moved during an image capture as determined by gyro information or as determined by comparing 2 or more pre-capture images. As previously discussed, step 230 in FIG. 3 (which corresponds to step 230 in FIG. 2) determines that α_{gmavg} is too great for a single-image capture. Consequently a multiple-image capture is deemed appropriate, because each of the multiple images can be captured with an exposure time less than tₜₒₜₐₗ, which produces an image with reduced blur. The reduced-blur images can then be synthesized into a single composite image with reduced blur.

In this regard, in step 330, the number of images n_{gm} to be captured in the multiple-image capture initially may be determined by dividing the average global motion blur α_{gmavg} by a desired maximum global motion blur αₘₐₓ in any single image captured in the multiple-image capture, as shown in Equation 1, below. For example, if the average global motion blur α_{gmavg} is eight pixels, and the desired maximum global motion blur αₘₐₓ for any one image captured in the multiple-image capture is one pixel, the initial estimate in step 330 of the number of images n_{gm} in the multiple-image capture is eight.

n_{gm}=α_{gmavg}/αₘₐₓ Equation 1

Consequently, as shown in Equation 2, below, the average exposure time t_{avg} for an individual image capture in the multiple-image capture is the total exposure time tₜₒₜₐₗ divided by the number of images n_{gm} in the multiple-image capture. Further, as shown in Equation 3, below, global motion blur α_{gm-ind} (in number of pixels shifted) within an individual image capture in the multiple-image capture is the global motion blur α_{gmavg} (in pixels shifted) over the total exposure time tₜₒₜₐₗ divided by the number of images n_{gm} in the multiple-image capture. In other words, each of the individual image captures in the multiple-image capture will have an exposure time t_{avg} that is less than the total exposure time tₜₒₜₐₗ and, accordingly, exhibits motion blur α_{gm-ind} which is less than the global motion blur α_{gmavg} (in pixels) over the total exposure time tₜₒₜₐₗ.

t_{avg}=tₜₒₜₐₗ/n_{gm} Equation 2

α_{gm-ind}=α_{gmavg}/n_{gm} Equation 3

tₛᵤₘ=t₁+t₂+t₃ . . . +t_{ngm} Equation 4

It should be noted that the exposure times t₁, t₂, t₃ . . . t_{ngm} for individual image captures 1, 2, 3 . . . n_{gm} within the multiple image capture set can be varied to provide images with varying levels of blur α₁, α₂, α₃ . . . α_{ngm} wherein the exposure times for the individual image captures average to t_{avg}.

In step 340, the summed capture time tₛᵤₘ (see Equation 4, above) may be compared to a maximum total exposure time γ, which may be determined to be the maximum time that an operator could normally be expected to hold the image capture device steady during image capture, such as 0.25 sec as an example. (Note: when the exposure time for an individual capture n is less than the readout time for the image sensor, so that the exposure time tₙ is less than the time between captures, the time between captures should be substituted for tₙ when determining tₛᵤₘ using Equation 4. The exposure time tₙ is the time that light is being collected or integrated by the pixels on the image sensor, and the readout time is the fastest time that sequential images can be readout from the sensor due to data handling limitations.) If tₛᵤₘ<γ then the current estimate of n_{gm} is defined as the number of multiple images in the multiple-image capture set in step 350. Subsequently, in step 260 in FIG. 2, execution of a multiple-image capture including n_{gm} images may be instructed.

Returning to the process described in FIG. 3, if tₛᵤₘ>γ in step 340, then tₛᵤₘ is to be decreased. Step 360 provides examples of two ways to reduce tₛᵤₘ: at least a portion of the images in the image capture set may be binned, such as by 2×, or the number of images to be captured n_{gm} may be reduced. One of these techniques, both of these techniques, or other techniques for reducing tₛᵤₘ, or combinations thereof may be used at step 360.

It should be noted that, binning is a technique for combining the charge of adjacent pixels on a sensor prior to readout through a change in the sensor circuitry thereby effectively creating a reduced number of combined pixels. The number of adjacent pixels that are combined together and the spatial distribution of the adjacent pixels that are combined over the pixel array on the image sensor can vary. The net effect of combining of charge between adjacent pixels is that the signal level for the combined pixel is increased to the sum of the adjacent pixel charges; the noise is reduced to the average of the noise on the adjacent pixels; and the resolution of the image sensor is reduced. Consequently, binning is an effective method for improving the signal to noise ratio, making it a useful technique when capturing images in low light conditions or when capturing with a short exposure time. Binning also reduces the readout time since the effective number of pixels is reduced to the number of combined pixels. Within the scope of the invention, pixel summing can also be used after readout to increase the signal and reduce the noise but this approach does not reduce the readout time since the number of pixels readout is not reduced.

After execution of step 360, the summed capture time tₛᵤₘ is recalculated and compared again to the desired maximum capture time γ in step 340. Step 360 continues to be repeatedly executed until tₛᵤₘ<γ, when the process continues on to step 350, where the number of images in the multiple-image capture set is defined.

FIG. 4 illustrates a method 400, according to a further embodiment of the invention, in which both global motion and local motion are evaluated to determine whether a multiple-image capture is appropriate. In step 410, pre-capture information is acquired, including at least 2 pre-capture images and the total exposure time tₜₒₜₐₗ needed to gather ζ electrons on average. The pre-capture images are then analyzed in step 420 to define both global motion blur and local motion blur present in the images, in addition to the average global motion blur α_{gmavg}. Wherein, local motion blur is distinguished as being different in magnitude or direction from global motion blur or average global motion blur. Consequently, in Step 420, if local motion is present, different motion will be identified in at least 2 different portions of the scene being imaged by comparing the 2 or more images in the multiple image capture set. The average global motion blur α_{gmavg} can be determined based on an entire pre-capture image or just portions of the pre-capture images that contain global motion and excluding the portions of the pre-capture images that contain local motion.

Also in step 420, the motion in the pre-capture images is analyzed to determine additional information including motion blur present in the scene, such as (a) global motion blur α_{gm-pre} (in pixels shifted) characterized as a pixel shift between corresponding pre-capture images and (b) local motion blur αₗₘ₋ₚᵣₑ characterized as a pixel shift between corresponding portions of pre-capture images. An exemplary article describing a variety of motion estimation approaches including local motion estimates is “Fast Block-Based True Motion Estimation Using Distance Dependent Thresholds” by G. Sorwar, M. Murshed and L. Dooley, Journal of Research and Practice in Information Technology, Vol. 36, No. 3, August 2004. While global motion blur typically applies to a majority of the image (as in the background of the image), the local motion blur applies only to one portion of the image, and different portions of an image may contain different levels of local motion. Consequently for each pre-capture image there will be one value for α_{gm-pre}, while there may be several values of αₗₘ₋ₚᵣₑ for different portions of the pre-capture image. The presence of local motion blur can be determined by subtracting α_{gm-pre} or α_{gmavg} from αₗₘ₋ₚᵣₑ or by determining the variation in the value or direction of αₗₘ₋ₚᵣₑ over the image.

In step 430, each pre-capture images's local motion is compared to a predetermined threshold ζ to determine whether the capture set needs to account for local motion blur. Wherein ζ is expressed in terms of a pixel shift difference from the global motion between images. If local motion <λ for all the portions of the image where local motion is present then it is determined that local motion does not need to be accounted for in the multiple-image capture, as shown in step 497. If local motion >λ for any portion of the pre-capture images, then the local motion blur that would be present in the synthesized image is deemed to be unacceptable and one or more local-motion images are defined and included in the multiple-image capture set in step 495. Wherein the local-motion images differ from the global motion images in that they have a shorter exposure time or a lower resolution (from a higher binning ratio) compared to the global motion images in the multiple image capture set.

It should be noted that, it is within the scope of the invention to define a minimum area of local motion needed to consider a region of a pre-capture image to have local motion, for purposes of the evaluation at step 430. For example, if only a very small portion of a pre-capture image exhibits local motion, such small portion may be neglected for purposes of the evaluation at step 430.

The number of global motion captures is determined in step 460 to reduce the global motion average blur α_{gmavg} to less than the maximum desired global blur αₘₐₓ. In step 470, the total exposure time tₛᵤₘ is determined as in step 340 with the addition that the number of local motion images, nₗₘ and the local motion exposure time, tₗₘ, identified at step 495 are included along with the global motion images in determining tₛᵤₘ. The processing of steps 470 and 480 in FIG. 4 differ from steps 340, 360 in FIG. 3 in that the local motion images are not modified by the processing of step 480. For example, when reducing tₛᵤₘ in step 480, only global-motion images are removed (n_{gm} is reduced) or the global motion images are binned. At step 490, the multiple-image capture is defined to include all of the local-motion images nₗₘ and the remaining global-motion images that make up n_{gm}.

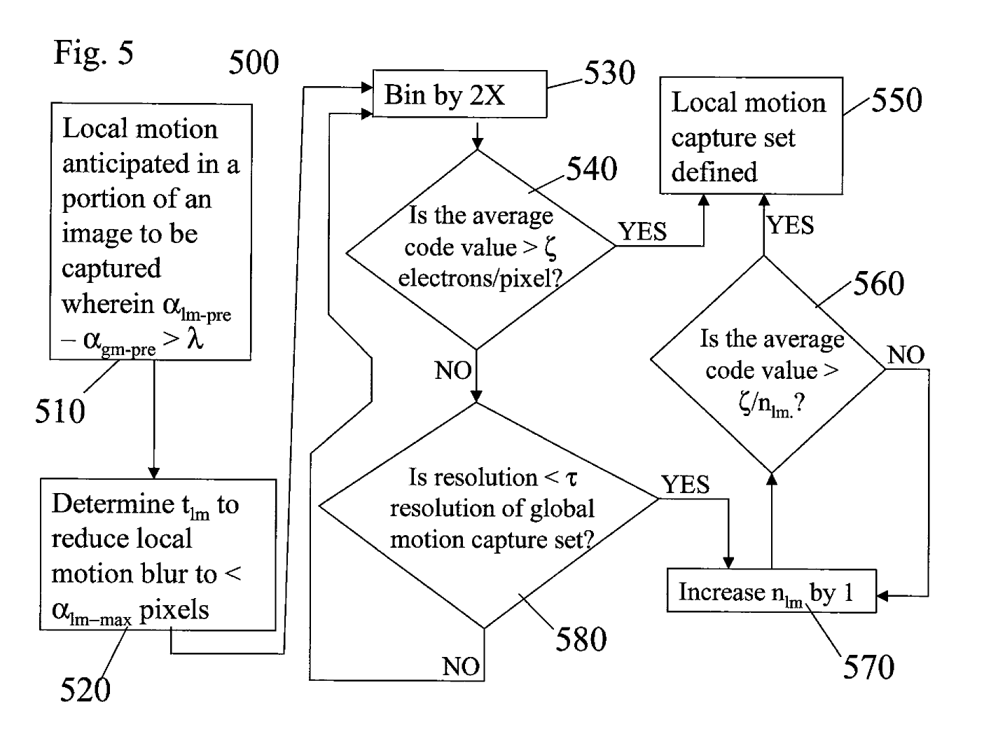

FIG. 5 illustrates a method 500 that expands upon step 495 in FIG. 4, according to an embodiment of the present invention, wherein one or more local-motion images (sometimes referred to as a “local motion capture set”) are defined and included in the multiple-image capture set. In step 510, local motion αₗₘ₋ₚᵣₑ−α_{gm-pre} greater than λ is detected in the pre-capture images for at least one portion of the image as in step 430. In step 520, the exposure time tₗₘ sufficient to reduce the excessive local motion blur αₗₘ₋ₚᵣₑ−α_{gm-pre} from step 510 to an acceptable level (αₗₘ₋ₘₐₓ) is determined as in Equation 5, below.

tₗₘ=t_{avg}(αₗₘ₋ₘₐₓ/(αₗₘ₋ₚᵣₑ−_{gm-pre})) Equation 5

At this point in the process, nₗₘ (the number of images in the local motion capture set) may initially be assigned the value 1. In step 530 the local motion image to be captured is binned by a factor, such as 2×. In step 540, the average code value of the pixels in the portion of the image where local motion has been detected is compared to the predetermined desired signal level ζ. If the average code value of the pixels in the portion of the image where local motion has been detected is greater than the predetermined signal level ζ, then the local motion capture set has been defined (tₗₘ, nₗₘ) as noted in step 550. If the average code value of the pixels in the portion of the image where local motion has been detected is less than ζ in step 540, then the resolution of the local motion capture set to be captured is compared to a minimum fractional relative resolution value τ compared to the global motion capture set to be captured in step 580. τ is chosen to limit the resolution difference between the local motion images and the global motion images so that τ could for example be ½ or ½. If the resolution of the local motion capture set compared to the global motion capture set is greater than τ in step 580, then the process returns to step 530 and the local motion images to be captured will be further binned by a factor of 2×. However, if the resolution of the local motion capture set compared to the global motion capture set is <τ then the process continues on to step 570 where the number of local motion captures in the local motion capture set, nₗₘ, is increased by 1 and the process continues on to step 560. In this way, if binning alone cannot increase the code value in the local motion images sufficiently to reach the desired ζ electrons/pixel average, the number of local motion images nₗₘ is increased.

In step 560, the average code value for the pixels in the portion of the image where local motion has been detected is compared to a predetermined desired signal level λ/nₗₘ that has now been modified to account for the increase in nₗₘ. If the average code value for the pixels in the portion of the image where local motion has been detected is less than ζ/nₗₘ, then the process returns to step 570 and nₗₘ is again increased. However, if the average code value for the pixels in the portion of the image where local motion has been detected is greater than ζ/nₗₘ, then the process continues on to step 550, and the local motion capture set is defined in terms of tₗₘ and nₗₘ. Step 560 insures that that average code value for the sum of the nₗₘ local motion images for the portion of the image where local motion has been detected will be >ζ and a high signal to noise ratio will be provided. It should be noted that local motion images in the local motion capture set can encompass the full frame or be limited to just the portion (or portions) of the frame where the local motion occurs in the image. It should be further noted that the process shown in FIG. 5 preferentially bins before increasing the number of captures but the invention could also be used with the number of captures increasing preferentially before binning.

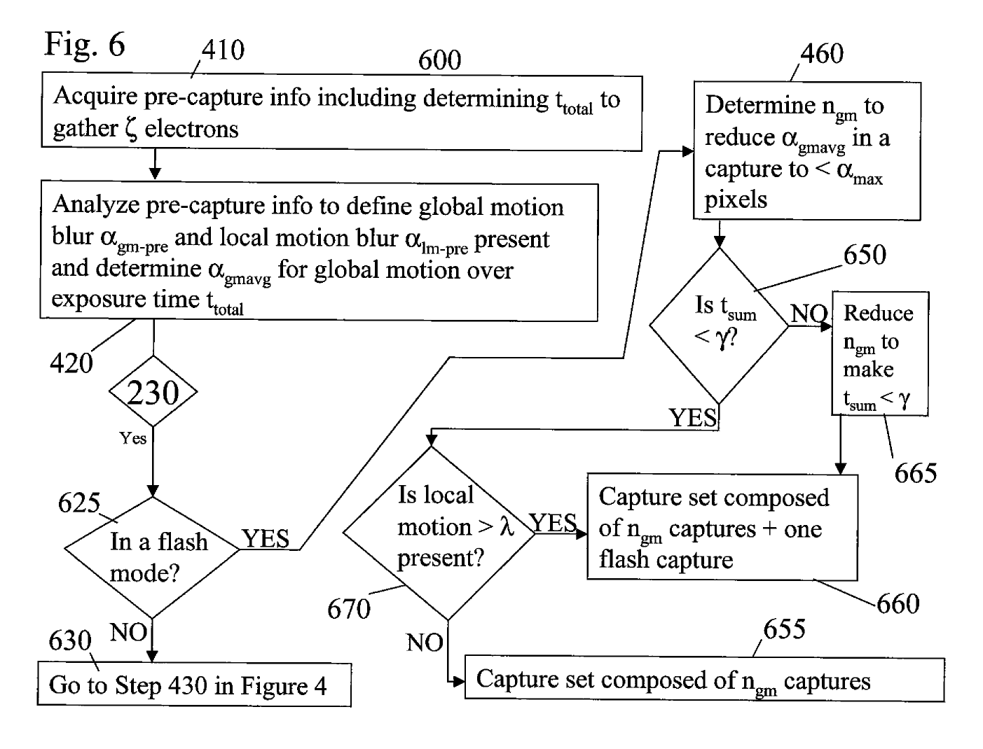

FIG. 6 illustrates a method 600 according to yet another embodiment of the invention in which flash is used to illuminate a scene during at least one of the image captures in a multiple-image capture. Steps 410, 420 in FIG. 6 are equivalent to those in FIG. 4. In step 625, the capture settings are queried to determine whether the image capture device is in a flash mode that allows the flash to be utilized. If the image capture device is not in a flash mode, no flash images will be captured, and in step 630 the process returns to step 430 as shown in FIG. 4.

If the image capture device is in a flash mode, then the process continues onto step 460 as has been described previously with respect to FIG. 4. In step 650, the summed exposure time tₛᵤₘ is compared to the predetermined maximum total exposure time γ, similar to step 470 in FIG. 4. However, if tₛᵤₘ<γ, the process continues to step 670 where a comparison of the local motion blur αₗₘ₋ₚᵣₑ is compared to the predetermined maximum local motion λ. If αₗₘ₋ₚᵣₑ<λ, then the capture set is composed of n_{gm} captures without flash as shown in step 655. If αₗₘ₋ₚᵣₑ>λ, then the capture set is modified in step 660 to include n_{gm} captures without flash and at least 1 capture with flash. If in step 650, tₛᵤₘ>γ, in step 665 n_{gm} is reduced to make tₛᵤₘ<γ and the process continues to step 660 where at least one flash capture is added to the capture set.

The capture set for a flash mode comprises n_{gm}, t_{avg} or t₁, t₂, t₃ . . . t_{ngm} and n_{fm}. Where n_{fm} is the number of flash captures when in a flash mode. It should be noted that when more than one flash captures are included, the exposure time and the intensity or duration of the flash can vary between flash captures as needed to reduce motion artifacts or enable portions of the scene to be lighted better during image capture.

Considering the method shown in FIGS. 4 and 6 the multiple image capture set can be comprised of heterogeneous images wherein at least some of the multiple images have different characteristics such as: resolution, integration time, exposure time, frame rate, pixel type, focus, noise cleaning methods, tone rendering, or flash mode. The characteristics of the individual images in the multiple image capture set are chosen to enable an improved image quality for some aspect of the scene being imaged.

Higher resolution is chosen to capture the details of the scene, while lower resolution is chosen to enable a shorter exposure and a faster image capture frequency (frame rate) when faster motion is present. Longer integration time or longer exposure time is chosen to improve the signal to noise ratio, while shorter integration time or exposure time is chosen to reduce motion blur in the image. Slower image capture frequency (frame rate) is chosen to allow longer exposure times, while faster image capture frequency (frame rate) is chosen to capture multiple images of a fast moving scene or objects.

Since different pixel types have different sensitivities to light from the scene, images can be captured that are preferentially comprised of some types of pixels over other types. As an example, if a green object is detected to be moving in the scene, an image may be captured from only the green pixels to enable a faster image capture frequency (frame rate) and reduced exposure time thereby reducing the motion blur of the object. Alternatively, for a sensor that has color pixels such as red/green/blue or cyan/magenta/yellow and panchromatic pixels, where the panchromatic pixels are approximately 3× as sensitive as the color pixels (see United States Patent Application (Docket 90627 by Hamilton)), images may be captured in the multiple capture set that are comprised of just panchromatic pixels to provide an improved signal to noise ratio while also enabling a reduced exposure or integration time compared to images comprised of the color pixels.

In another case, images with different focus position or f# can be captured and portions of the different images used to produce a synthesized image with wider depth of field or selective areas of focus. Different noise cleaning methods and gain settings can be used on the images in the multiple image capture set to produce some images for example where the noise cleaning has been designed to preserve edges for detail and other images where the noise cleaning has been designed to reduce color noise. Likewise, the tone rendering and gain settings can be different between images in the multiple image capture set where for example high resolution/short exposure images can be rendered with high contrast to emphasize edges of objects while low resolution images can be rendered in saturated colors to emphasize the colors in the image. In a flash mode, some images can be captured with flash to reduce motion blur while other images are captured without flash to compensate for flash artifacts such as red-eye, reflections and overexposed areas.

After heterogeneous images have been captured in the multiple image capture set, portions of the multiple images are used to synthesize an improved image as shown in FIG. 2, Step 270.

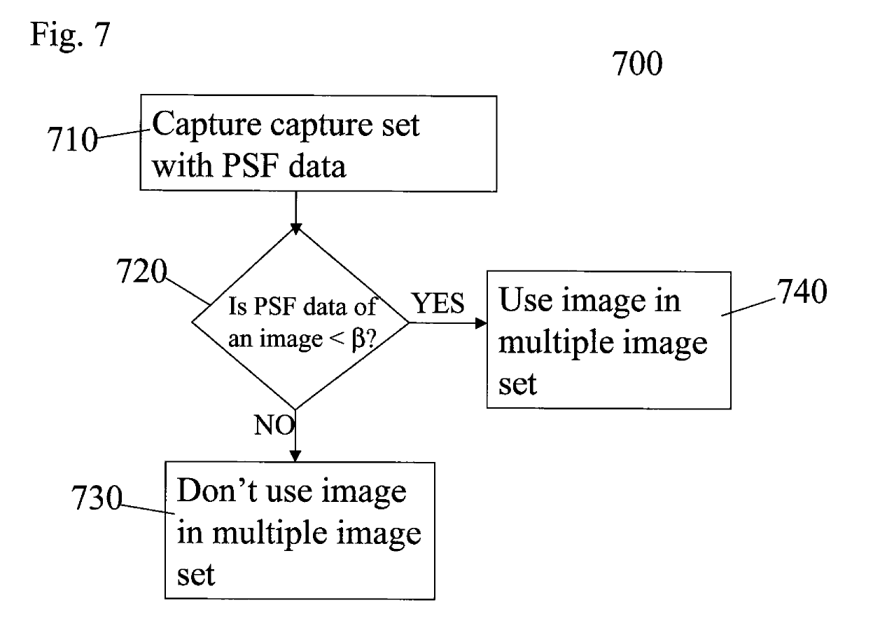

FIG. 7 illustrates a method 700 according to an embodiment of the present invention for synthesizing multiple images from a multiple-image capture into a single image, for example, by leaving out high-motion images from the synthesizing process. High motion images are those images which contain a large amount of global motion blur. By leaving images with a large amount of motion blur out of the synthesized single image or composite image produced from the multiple image capture, the image quality of the synthesized single image or composite image is improved In step 710, each image in the multiple-image capture is obtained along with point spread function (PSF) data. PSF data describes the global motion that occurred during the image capture as opposed to pre-capture motion blur values α_{gm-pre} and αₗₘ₋ₚᵣₑ which are determined from pre-capture data. As such, PSF data is used to identify images where the global motion blur during image capture was larger than was anticipated based on the pre-capture data. PSF data can be obtained from a gyro in the image capture device using the same vibration sensing data provided by a gyro sensor that is used for image stabilization as described in U.S. Pat. No. 6,429,895 by Onuki. PSF data can also be obtained from image information that is obtained from a portion of the image sensor being readout at a fast frame rate as described in U.S. patent application Ser. No. 11/780,841 (Docket 93668).

In step 720, the PSF data for an individual image is compared to a predetermined maximum level β. In this regard, the PSF data can include motion magnitude during the exposure, velocity, direction, or direction change. The values for β will be similar to the values for αₘₐₓ in terms of pixels of blur. If the PSF data >β for the individual image, the individual image is determined to have excessive motion blur. In this case, in step 730, the individual image is set aside thereby forming a reduced set of images and the reduced set of images is used in the synthesis process of Step 270. If the PSF data <β for the individual image, the individual image is determined to have an acceptable level of motion blur. Consequently, in step 740, it is stored along with the other images from the capture set that will be used in the synthesis process of Step 270 to form an improved image.

It is to be understood that the exemplary embodiments are merely illustrative of the present invention and that many variations of the above-described embodiments can be devised by one skilled in the art without departing from the scope of the invention. It is therefore intended that all such variations be included within the scope of the following claims and their equivalents.
430 step
460 step
470 step
480 step
490 step
495 step
497 step
500 A process flow diagram for still further an embodiment of the invention that expands upon step 495 in FIG. 4
510 step
520 step
530 step
540 step
550 step
560 step
570 step
580 step
600 A process flow diagram for yet another embodiment of the invention wherein a flash mode is disclosed
625 step
630 step
650 step
655 step
660 step
665 step
670 step
700 A process flow diagram for still another embodiment of the invention wherein capture conditions are changed in response to changes in the scene being imaged between captures of the images in the capture set
710 step
720 step
730 step
740 step

1. A method implemented at least in part by a data processing system, the method for controlling an image capture and comprising the steps of:
acquiring pre-capture information;
determining that a multiple image capture is appropriate based at least upon an analysis of the pre-capture information, wherein the multiple-image capture is configured to acquire multiple images for synthesis into a single image; and
instructing execution of the multiple-image capture.

2. The method of claim 1, wherein the multiple-image-capture includes capture of heterogeneous images.

3. The method of claim 2, wherein the heterogeneous images differ by resolution, integration time, exposure time, frame rate, pixel type, focus, noise cleaning methods, tone rendering, or flash mode.

4. The method of claim 3, wherein the pixel types of different images of the heterogeneous images are a pan pixel type and a color pixel type.

5. The method of claim 3, wherein the noise cleaning methods include adjusting gain settings.

6. The method of claim 1, further comprising the step of determining an image-capture-frequency for the multiple-image capture based at least upon an analysis of the pre-capture information.

7. The method of claim 1, wherein the pre-capture information indicates at least scene conditions, and wherein the determining step includes determining that a scene cannot be captured effectively by a single image-capture based at least upon an analysis of the scene conditions.

8. The method of claim 7, wherein the scene conditions include a light-level of the scene, and wherein the determining step determines that the light-level is insufficient for the scene to be captured effectively by a single image-capture.

9. The method of claim 1, wherein the pre-capture information includes motion of at least a portion of a scene, and wherein the determining step includes determining that the motion would cause blur to be too great in a single image-capture.

10. The method of claim 9, wherein the motion is local motion present only in a portion of the scene.

11. The method of claim 10, wherein the determining step includes determining, in response to the local motion, that the multiple-image-capture is to be configured to capture multiple heterogeneous images.

12. The method of claim 11, wherein at least one of the multiple heterogeneous images includes an image that includes only the portion or substantially the portion of the scene exhibiting the local motion.

13. The method of claim 1, wherein the pre-capture information includes motion information indicating different motion in at least two portions of a scene, and wherein the determining step determines that at least one of the different motions would cause blur to be too great in a single image-capture.

14. The method of claim 1, wherein the multiple-image-capture acquires a plurality of images, and wherein the method further comprises the steps of eliminating images from the plurality of images exhibiting a high point spread function, thereby forming a reduced set of images, and synthesizing the reduced set of images into a single synthesized image.

15. A processor-accessible memory system storing instructions configured to cause a data processing system to implement a method for controlling an image capture, wherein the instructions comprise:
instructions for acquiring pre-capture information;
instructions for determining that a multiple-image capture is appropriate based at least upon an analysis of the pre-capture information, wherein the multiple-image capture is configured to acquire multiple images for synthesis into a single image; and
instructions for instructing execution of the multiple-image capture.

16. A system comprising:
a data processing system; and
a memory system communicatively connected to the data processing system and storing instructions configured to cause the data processing system to implement a method for controlling an image capture, wherein the instructions comprise:
instructions for acquiring pre-capture information;
instructions for determining that a multiple-image capture is appropriate based at least upon an analysis of the pre-capture information, wherein the multiple-image capture is configured to acquire multiple images for synthesis into a single image; and
instructions for instructing execution of the multiple-image capture.
